(19) United States
(12) Patent Application Publication
(10) Pub. No.: US 2008/0266125 A1
(43) Pub. Date: Oct. 30, 2008

(54) Method for Actively Monitoring Pipelines

(76) Inventors: Stefan Windisch, Oberolm (DE); Alexander Heinl, Mainz (DE)

Correspondence Address: BODNER & O'ROURKE, LLP, 425 BROADHOLLOW ROAD, SUITE 108, MELVILLE, NY, 11747, US

(21) Appl. No.: 11/547,381

(22) PCT Filed: Mar. 30, 2005
(86) PCT No.: PCT/EP05/03336

§ 371 Date: Dec. 26, 2007

(30) Foreign Application Priority Data
Apr. 2, 2004 (DE) 10 2004 016 378.2

(51) Int. Cl. G08B 21/00; G01M 3/28

(52) U.S. Cl. 340/605; 73/40.5 R

(57) ABSTRACT

The invention relates to a method for actively monitoring pipelines guiding pressurized media and consumers, which are connected to the respective pipeline or pipeline system, by means of differential pressure measurement. According to the invention, monitoring occurs as to whether permanent and quasi-constant consumption takes place during a specific time period, preferably at the transfer point or behind the point of transfer between the supply device and consumer connection in a continuous manner or in predetermined cycles. If this is the case, it is possible to deduce an abnormal state, e.g. a leak, and an alarm is triggered or the downstream pipeline system is blocked. A series connection, consisting of a first pressure sensor, an electrically or hydraulically actuatable valve and a second sensor, is provided on the device side at or behind the transfer point between the supply device and consumer connection, wherein a control electronics system is connected to the pressure sensors and the valve actuation device, in order to produce an error signal when a decrease in pressure has been recognized per time unit after the valve has been blocked in a controlled manner.

The invention relates to a method for actively monitoring pipelines conducting pressurized fluid media as well as the consumers connected to the respective pipeline or pipeline system by means of differential pressure measurement in accordance with the precharacterizing part of claim 1.

Pipeline system arrangements comprising sensors capable of detecting water leaks are known, e.g. for a building's water supply. Such sensors have an alarm device mechanism, for example to visually and/or acoustically signal a water leak. Yet in all cases of such sensors in actual use, damage has already occurred and there is already a more or less large volume of water inside a building or an apartment along with all the known consequential damage.

Furthermore known are mechanical blocking devices as, for example, integrated into the water inlet hoses of washing machines, dishwashers or other such similar consumers.

Upon sudden changes in pressure, e.g. upon a water inlet hose bursting or slipping out of a hose clip, the integrated valve will close. While this will minimize the volume of water which leaks out, such prior art solutions are not suitable for monitoring complex pipelines or pipeline systems having a plurality of connected consumers. In addition, a minimum pressure difference is necessary in order for the valve to be actuated.

DE 196 35 789 A1 discloses an electronic system for measuring liquid or gas consumption, wherein two pressure sensors are provided in the line path section with which consumption can be measured. In concrete terms, a pressure variation leak test is applied which can also be evaluated over time. The cited published application moreover explains how the pipes can be fitted with various different flow resistors in the form of diaphragms or nozzles in order to induce an artificial increase in pressure at or downstream the flow resistors.

Prior art reference is also to be made to FR 2 467 388, which discloses a Venturi nozzle as the diaphragm, disposed in the proximity of sensors, whereby the sensors are connected as a type of measuring bridge.

DE 43 08 313 A1 describes a device for determining the flow rate of a liquid medium according to the differential pressure principle. It emphasizes that the effective pressure required at a throttle point is to be produced by a constricted flow cross-section within a short path length which then, however, results in very narrow cross-sections when the lowest flow rates are to be determined, the consequence being possible blockages in the effective pressure line.

Yet the previously-cited prior art only discloses using differential pressure measurement for the purpose of determining the consumption of fluids. No suggestions can be inferred from the known solutions as to using a related method for determining actual leaks while also considering the very high fluctuations in pressure which occur during normal consumption.

Additional prior art includes DE 198 14 903 C2, related to a method of preventatively shutting off a supply line for a medium contingent upon the user's consumption habits and the pressure measurement in the lines, as well as DE 197 06 564 A1, directed toward a leak detector and emergency stop mechanism for households.

DE 197 06 564 A1, which can be regarded as type-generic, makes use of a pressure difference measurement with subsequent processor-based pressure evaluation. If one considers the disclosure of DE 197 06 564 A1, the contention can then be made that a shut-off command is triggered upon the exceeding of a predefined water leak. Thusly, no special determination of the leakage is made. To the contrary, it is proposed to provide a further flow-rate counter to detect water consumption, whereby its measured data should then enable a control unit to make an assessment as to actual leakages.

Based on the foregoing, it is thus the task of the invention to provide a further developed method for actively monitoring pipelines conducting pressurized fluid media as well as the consumers connected to the respective pipeline or pipeline system which thereby draws on the known principle of differential pressure measurement. The method to be afforded is thus to provide the opportunity of monitoring an entire pipeline system having a plurality of wholly different connected consumers, fixtures, pipes and the like, e.g. in an apartment building, whereby it is simultaneously possible to effect a complete shut-off of the fluid-conducting pipeline system in the event of emergency; i.e., in the event of recognized disaster.

In addition, it is to be ensured that an arrangement based on the active monitoring method can be produced at a reasonable cost and can be installed with reasonable effort, without resulting in disadvantageous consequences for the system flow conditions when operating a system equipped with such an inventive supplement.

The solution to the task of the invention follows in accordance with the definition according to claim 1, whereby the subclaims comprise at least practical embodiments or further developments.

Accordingly, it is preferable to monitor at or behind the transfer point between supply installation and consumer connection, e.g. the building connection, on a continuous basis or in pre-defined cycles as to whether there is permanent and quasi-constant consumption during a predefinable interval of time. An abnormal state in this case would lead, for example, to conclusion of a leak, upon which the triggering of an alarm and/or blocking of the downstream pipeline system follows.

In leakage determination operation, a valve provided at or behind the transfer point is closed so that the downstream pipeline system is shut off at least temporarily. In this state, the inlet pressure at that particular moment is determined and saved. Based on same, the drop in pressure relative the saved inlet pressure value and the measured outlet pressure is determined and an evaluation follows as to whether the determined decrease in pressure per unit of time exceeds a predefined value, whereupon an error in the pipeline system is concluded.

In so-called dispensing operation, the above-mentioned valve disposed at or behind the transfer point is opened and pressure difference variations in the pressure values in front of and behind the valve are recorded.

Upon there no longer being any changing pressure difference values over a predefined period of time, the operating modes then change.

In principle, switching between leak determination operation and dispensing operation is ongoing, whereby the change is triggered as a function of determined pressure fluctuations at consumer dispensing locations. As a rule, the above-mentioned switching between the individual modes occurs several times within an hour.

The alerting or alarm forwarding can be made over a public telecommunication system or by radio signal. Conceivable would be connecting the alarm device to an automatic GSM dialplate or to a mechanism connected to the landline telephone network.

The error values determined in leak determination mode are saved, whereby the triggering of an alarm and/or blocking of the system then follows if the error amount as added up in the memory exceeds a threshold value. In the case of a consumer operating at an intentionally longer, continuous withdrawal of media, e.g. garden irrigation, a varying flow-rate element is used, whereby this element periodically or stochastically changes the consumer-contingent flow rate.

As far as the arrangement itself for actively monitoring pipelines conducting pressurized fluid media as well as the consumers connected to the respective pipeline or pipeline system by means of differential pressure measurement at or behind the transfer point between supply installation and consumer connection, a series connection of a first pressure sensor, an electrically or hydraulically actuatable valve and a second pressure sensor is provided, whereby control electronics are connected to the pressure sensors and the valve actuating device in order to produce an error signal upon a pressure decrease being recognized per time unit following a controlled shut-off of the valve.

The valve provided can be a pneumatic valve or a solenoid valve having a manual override, whereby the pressure sensors can be realized as piezo sensors.

The control electronics used to realize the method comprise a processor, a control unit, a power supply and interfaces for connectable periphery. To avoid problems in the event of power failure, the power supply can be buffered through secondary elements; i.e., in this case providing for an uninterruptible power supply.

The invention is based on the premise that permanent and constant water consumption over time intervals can represent a failure within the monitored system.

When initiating operation of the arrangement according to the invention, the user is first prompted to close all water intakes. The valve provided thereafter opens and a system calibration takes place. Offset errors of the sensors employed and conversion errors are compensated in this step.

The same applies to pressure fluctuations resulting from the sensor offset or the natural fluctuations in supply pressure caused by consumers external the monitored system or by the water supplier itself.

Optionally, the tightness to the entire system can now be checked.

After the valve closes, the minimum decrease in pressure is determined over a fixed period of time. Such a minimum decrease in pressure is given by dripping faucets or toilet tanks, for example.

In a next step, a maximum water consumption with the longest uniform flow rate is saved. To this end, a bathtub is filled completely, for example, or a defined time period ensues.

The valve is subsequently opened and the arrangement according to the invention determines the maximum time interval which a consumer needs without any variation.

The valve is opened in dispensing operation and the pressure difference, measured through the slot valve, is determined. In this mode, only the variation in pressure difference applies. Should the pressure difference no longer have changed during the previously-determined maximum time interval, this then denotes either no consumer or a permanent consumer, and the system automatically changes into another operating mode.

Leakage determination operation is initiated by the valve shutting off the water supply. The momentary input pressure here is furthermore saved, which serves the accurate measurement of the drop in pressure within the path being monitored since external interferences are no longer relevant.

With closed valve, the decrease in pressure, calculated from the saved input pressure and the measured output pressure, is compared to the minimum drop in pressure per time unit. The minimum decrease in pressure per time unit was established or determined at start-up from the system leak-tightness check.

Should this drop in pressure per time be exceeded, there is either a leak in the system or a consumer needs water for a longer period than was established in start-up mode.

The results now received are recorded in a memory as a possible monitored system error and operation switches back to dispensing mode.

Should, however, the drop in pressure per time not be exceeded, a normal condition is assumed and the fault memory is deleted. The system then switches back to dispensing mode.

As stated, there is normally an ongoing switching between dispensing operation and leakage determination mode. The user does not, however, notice this change since switching occurs very quickly and the drops in pressure during switching on/off, valve actuation respectively, are very low.

The respective state of the monitored pipeline system is saved in the fault memory. Should leakage detection have resulted in an error multiple times and the sum of the errors when added up exceed a set value, a significant error within the monitored pipeline or pipeline system can be assumed. In this case, the valve is closed on a sustained basis and a control or intervention on the part of the user is necessary.

To circumvent the protective function, e.g. in the event of a fire or equipment defect, it is preferable to provide a manual override on the valve in the sense of a bypass.

The following will make reference to an embodiment as well as the figures in describing the invention in greater detail.

### Shown are:

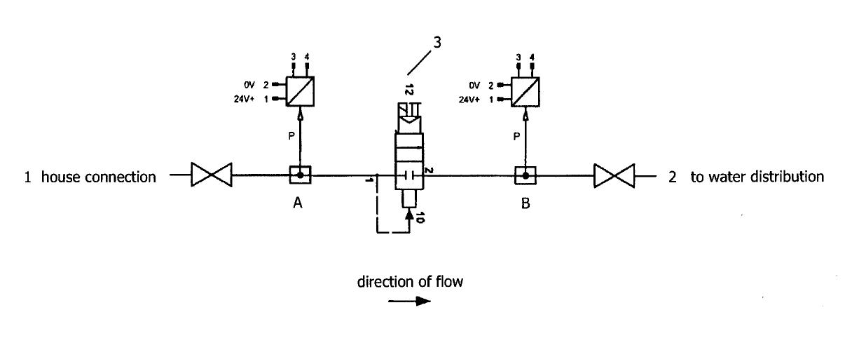

FIG. 1 a diagram of the fluidic arrangement, and

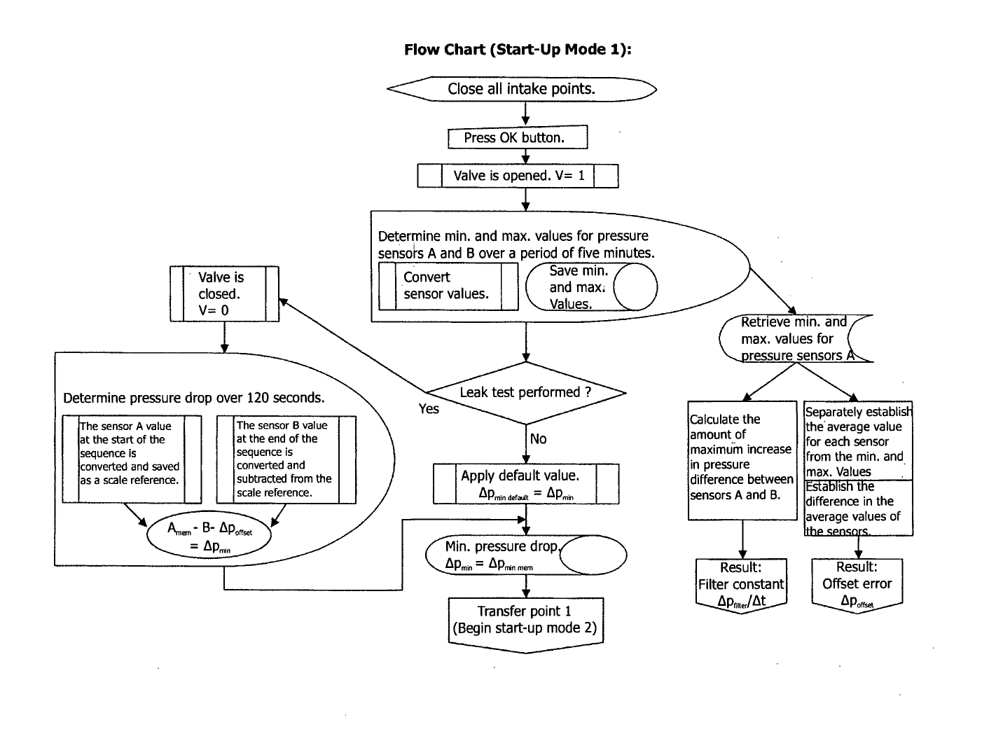

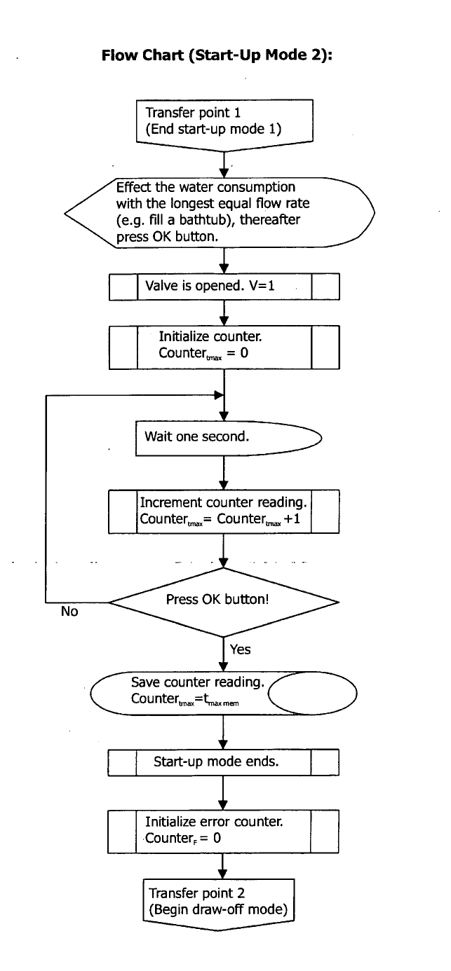

FIGS. 2 to 5 flow charts of the various different operating or analysis modes of the arrangement according to the invention.

In accordance with FIG. 1, the arrangement for actively monitoring pipelines is looped between a building connection 1 and the water distribution means 2, e.g. for a multi-family building.

The arrangement comprises a first pressure sensor A with a solenoid valve 3 and a second pressure sensor B arranged downstream therefrom in the direction of flow.

Piezoelectric pressure gauges active in a range between 0 and 6 bar and having a current output in the range of between 4 mA and 20 mA are preferably employed as pressure sensors A, B, same which can be additionally employable for error detection.

An indirectly-actuated electromagnetic valve offering the possibility of a manual override setting is employed as valve 3.

The control electronics not representationally depicted are connected to pressure sensors A, B and solenoid valve 3 and comprise an arrangement of display, keys and interfaces, respectively connection possibilities to peripheral equipment, e.g. for forwarding an established abnormal state or triggering an alarm respectively.

The control electronics realize the functionality as illustrated in the flow charts according to FIGS. 2 to 5.

The description of the individual flow charts according to FIGS. 2 to 5 shall be regarded as an express disclosure essential to the invention, whereby in order to avoid repetition, reference is made to the descriptions as provided in FIGS. 2 to 5.

In the start-up mode, a request first issues to the effect that all conceivable points of usage, i.e. conceivably connected consumers, need to be closed. Following an OK confirmation via a control keyboard as provided, the control electronics then initiate an opening of the valve 3 pursuant FIG. 1. Subsequent thereto, a determination of minimum and maximum values is made for pressure sensors A and B, for example over a period of 5 minutes. These measured values are converted and stored in an intrasystem memory. A calculation is made from these values of the amount of maximum increase in pressure difference between sensor A and B, as is a separate determination of the average of the minimum and maximum values for each sensor. A filter constant is determined from these values on the one hand, as is any conceivable offset error on the other.

In the event that a leak test is not necessary, system default values are used for the further evaluation or further operation of the arrangement.

The further step of the start-up comprises initiating water consumption using the longest possible uniform flow rate or a defined period of time.

According thereto, the system determines the maximum time interval that a consumer requires without variation. Subsequent this procedure, repeated as necessary, the start-up procedure is ended and initializing of an intra-system error counter follows.

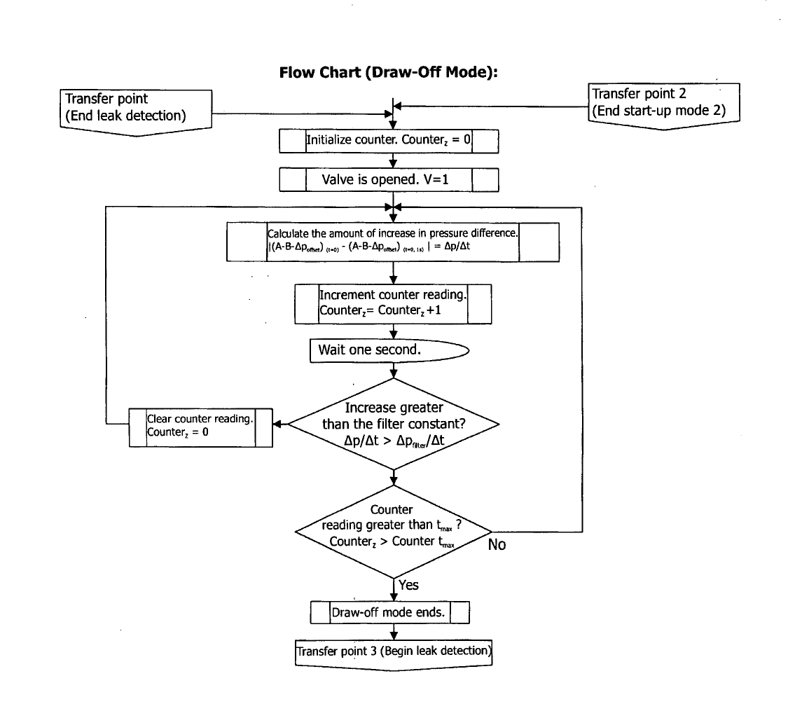

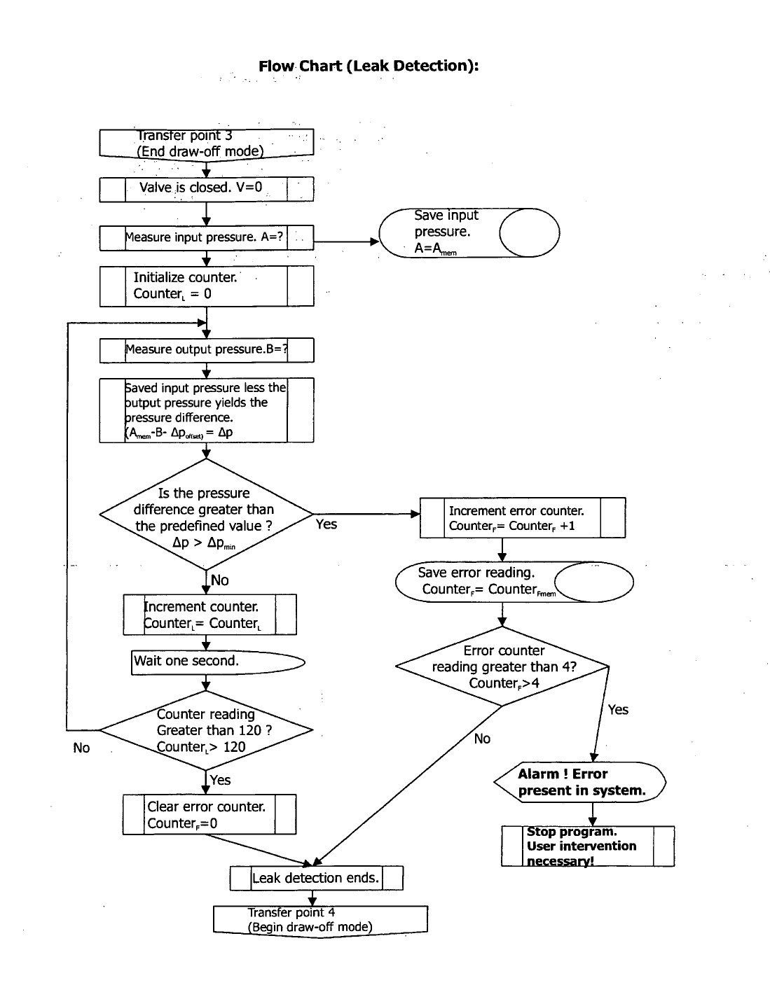

In the dispensing mode according to FIG. 4, valve 3 opens and the pressure difference measured by the valve is determined, whereby solely of relevance here is the pressure difference changes. Then, as shown in FIG. 4, when the pressure difference no longer exhibits a change over the course of the previously-defined maximum period of time, there is either no consumer connected or there is a permanent consumption, whereupon the switch is then made to the leakage determination mode pursuant FIG. 5 and its flow chart.

In leakage determination mode, the water supply is first shut off by means of valve 3 and a measuring and saving of the input pressure follows. After counter initializing, the output pressure is determined. The saved input pressure less the output pressure then yields the desired and sought pressure difference. When the difference in pressure is greater than a previously-defined value, it is stored as an error state. At the same time, an incrementing of a provided error counter ensues. Should, for example, the error counter state be greater than 4, an alarm is triggered. Should this not be the case, the leak detection is defined as terminated.

Then, when the pressure difference is not greater than the predefined value, a renewed check and measurement of the output pressure with the subsequent pressure difference determination ensues with a further counter. In accordance with the embodiment, this procedure can be repeated up to 120 times. If the maximum number of check routines have been processed, the relevant counter is set to 0 and the leak detection is declared terminated; i.e., transition to dispensing mode follows.

All in all, the arrangement and associated method described above succeeds in establishing a pipeline system monitoring which not only provides the desired control of all consumers and the entire pipeline, but also shuts off the water supply at the transfer point to the monitored equipment so that any damages which might occur can be successfully prevented, thus averting water damage or high incidental water consumption along with the resultant associated costs.

### REFERENCE NUMERALS

1 building connection
2 water distribution means
A first pressure sensor
B second pressure sensor
3 solenoid valve

1. A method for actively monitoring pipelines conducting pressurized fluid media as well as the consumers connected to the respective pipeline or pipeline system by means of differential pressure measurement, wherein it is preferable to monitor at or behind the transfer point between supply installation and consumer connection on a continuous basis or in pre-defined cycles as to whether there is a permanent and quasi-constant consumption during a predefinable interval of time, wherein should this be the case, an abnormal state can be concluded, for example a leak, and the triggering of an alarm and/or blocking of the downstream pipeline system then follows,
characterized in that
in leakage determination operation, a valve provided at or behind the transfer point blocks the downstream pipeline system, wherein the inlet pressure at that particular moment is determined and saved, based on which the decrease in pressure relative the saved inlet pressure and the measured outlet pressure is determined and then assessed as to whether the determined decrease in pressure per unit of time exceeds a predefined value, whereupon an error in the pipeline system is concluded.

2. The method according to claim 1,
characterized in that
in dispensing operation, the valve provided at or behind the transfer point is or is to be opened and the pressure difference variations in the pressure values in front of and behind the valve are recorded.

3. The method according to claim 2,
characterized in that
a change in operating mode ensues upon there no longer being any changing pressure difference values over a predefined period of time.

4. The method according to claim 1,
characterized in that
there is a permanent switching between leakage determination operation and dispensing operation.

5. The method according to claim 4,
characterized in that
the change is triggered as a function of determined pressure fluctuations occurring at consumer dispensing locations.

6. The method according to claim 1, characterized in that
the alerting or alarm forwarding ensues over a public telecommunication system or by radio signal.

7. The method according to claim 1,
characterized in that
the error values are saved, wherein the triggering of an alarm and/or blocking of the system then follows if the error number exceeds a threshold value.

8. The method according to claim 1, characterized in that
a varying flow-rate element is used for consumers operating at an intentionally longer, continuous withdrawal of media, wherein said element periodically or stochastically changes the consumer-contingent flow rate.

9. The method according to claim 2,
characterized in that
there is a permanent switching between leakage determination operation and dispensing operation.

10. The method according to claim 3,
characterized in that
there is a permanent switching between leakage determination operation and dispensing operation.

11. The method according to claim 2,
characterized in that
the alerting or alarm forwarding ensues over a public telecommunication system or by radio signal.

12. The method according to claim 3,
characterized in that
the alerting or alarm forwarding ensues over a public telecommunication system or by radio signal.

13. The method according to claim 4,
characterized in that
the alerting or alarm forwarding ensues over a public telecommunication system or by radio signal.

14. The method according to claim 5,
characterized in that
the alerting or alarm forwarding ensues over a public telecommunication system or by radio signal.

15. The method according to claim 2,
characterized in that
a varying flow-rate element is used for consumers operating at an intentionally longer, continuous withdrawal of media, wherein said element periodically or stochastically changes the consumer-contingent flow rate.

16. The method according to claim 3,
characterized in that
a varying flow-rate element is used for consumers operating at an intentionally longer, continuous withdrawal of media, wherein said element periodically or stochastically changes the consumer-contingent flow rate.

17. The method according to claim 4,
characterized in that
a varying flow-rate element is used for consumers operating at an intentionally longer, continuous withdrawal of media, wherein said element periodically or stochastically changes the consumer-contingent flow rate.

18. The method according to claim 5,
characterized in that
a varying flow-rate element is used for consumers operating at an intentionally longer, continuous withdrawal of media, wherein said element periodically or stochastically changes the consumer-contingent flow rate.

19. The method according to claim 6,
characterized in that
a varying flow-rate element is used for consumers operating at an intentionally longer, continuous withdrawal of media, wherein said element periodically or stochastically changes the consumer-contingent flow rate.

20. The method according to claim 7,
characterized in that
a varying flow-rate element is used for consumers operating at an intentionally longer, continuous withdrawal of media, wherein said element periodically or stochastically changes the consumer-contingent flow rate.
